(19) United States
(12) Patent Application Publication
(10) Pub. No.: US 2015/0156231 A1
(43) Pub. Date: Jun. 4, 2015

(54) METHOD AND A SERVER OF RESERVING CONFERENCE HARDWARE RESOURCES

(71) Applicant: ORANGE, Paris (FR)

(72) Inventor: Yoann NOISETTE, Paris (FR)

(21) Appl. No.: 14/556,003

(22) Filed: Nov. 28, 2014

(30) Foreign Application Priority Data
Nov. 29, 2013 (FR) 1361894

(51) Int. Cl. H04L 29/06

(52) U.S. Cl. CPC H04L 65/403

(57) ABSTRACT

One embodiment disclosed herein is a reservation method comprising receiving an invitation message to a conference from a device associated with the organizer of the conference, the invitation message identifying at least one participant distinct from the organizer, a search process performed on behalf of the participant(s) identified in the invitation message, of searching for conference hardware resources appropriate for the conference and for the participant(s), a reservation process performed for the participant(s), of reserving the hardware resource(s), if any, identified during the search process, and sending a notification message to the device(s) of the participant(s) specifying the server hardware resource(s).

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57 in their entireties. In particular, the disclosure of French Application 1361894, filed Nov. 29, 2013, is incorporated herein by reference in its entirety.

### BACKGROUND OF THE INVENTION

Some embodiments of the invention relate to the general field of telecommunications. It relates precisely to conference services. By way of example, a conference may be a video conference or an audio conference.

Video conference services present numerous advantages for businesses and for individuals. They provide an advantageous alternative to attending meetings in person, in particular in terms of cost and time, in particular by making it possible to limit physical travelling by the participants.

Although more and more video conference services can be used with personal and/or mobile terminals (smartphones, tablets, etc.), it is nevertheless found that using dedicated video conference rooms remains the solution in the most widespread use, particularly in a professional context. Such installations that are specially equipped for this purpose advantageously replace physical meetings, while preserving the comfort and the experience of users. Thus, in so-called “immersive” rooms, having large screens and high quality sound devices, the participants have the impression of all being physically located in the same room.

Nevertheless, organizing a video conference remains an operation that is laborious in terms of user experience. The organizer of a video conference needs initially to invite the various participants, and then needs to ensure that video conference rooms are reserved for those various participants depending on their geographical locations. Each of those processes may possibly be made easier by using dedicated computer means, such as for example email, for sending invitations to the video conference, or a reservation portal for allocating video conference rooms. Nevertheless, the organization performed in that way remains complicated for a user.

### OBJECT AND SUMMARY OF THE INVENTION

In some embodiments, the present invention makes it possible in particular to mitigate the above-mentioned drawbacks by proposing a reservation method that is to be performed by a conference hardware resource reservation server, the method comprising:

receiving an invitation message to a conference from a device of an organizer of the conference, the invitation message identifying at least one participant different from the organizer of the conference;

a search process performed on behalf of said at least one participant identified in the invitation message, of searching for a conference hardware resource appropriate for the conference and for said participant;

a reservation process performed on behalf of said at least one participant, of reserving the hardware resource, if any, identified during the search process; and

sending a first notification message to a device of said at least one participant, this first notification message specifying the hardware resource reserved for that participant.

Correspondingly, in some embodiments, the invention also provides, in a second aspect, a conference hardware resource reservation server comprising:

a reception module which receives an invitation message to a conference from a device of an organizer of the conference, the invitation message identifying at least one participant different from the organizer of the conference;

a search module which acts on behalf of said at least one participant identified in the invitation message, to search for a conference hardware resource appropriate for the conference and for the participant;

a reservation module which reserves the hardware resource, if any, identified for said at least one participant; and

a send module which sends a notification message to a device of said at least one participant, this notification message specifying the hardware resource reserved for that participant.

Correspondingly, in a third aspect, the invention also provides a method performed by a device of an organizer of a conference for requesting the reservation of conference hardware resources, the method comprising sending a conference invitation message to a reservation server, the invitation message identifying at least one participant distinct from the organizer of the conference.

Correspondingly, in a fourth aspect, the invention also provides a method of receiving an invitation to a conference, the method being performed by a device of at least one participant and comprising receiving a notification message from a reservation server, this notification message specifying a hardware resource reserved by the server for the participant, the hardware resource being appropriate for the conference and for the participant.

In the meaning of the invention, the term “conference hardware resources” covers any hardware resources enabling one or more people to participate in a conference, and in particular conference rooms provided for this purpose and incorporating equipment needed for holding a conference, such as for example screens, cameras, and loudspeakers. Such hardware resources may be characterized by the equipment constituting the hardware, by its capacity, its availability, and its geographical location.

In some embodiments, the invention thus facilitates the user experience of the organizer of a conference by giving the task of reserving the hardware resources needed by the participants of the conference to a reservation server that is dedicated to that purpose and that is activated on receiving an invitation message issued by the conference organizer. The organizer thus needs only to send an invitation to the conference identifying the participants, this message being sent to the devices of the participants without the organizer needing to worry about reserving the hardware resources needed for holding the conference. The reservation of the hardware resources is carried out by the reservation server in a manner that is transparent or almost transparent for the organizer.

It should be observed that the organizer may also be a participant to the conference. Under such circumstances, the reservation server proceeds in the same manner as for the other participants and reserves the hardware resource needed by the organizer. In other words, the reservation method also performs the search, reservation, and send processes for the organizer of the conference.

In a variant, the organizer need not participate in the conference but may organize it, e.g. on behalf of one of the participants (this applies for example when an executive assistant organizes the conference on behalf of a third party). Under such circumstances, the reservation server does not make a reservation for the organizer.

This solution, which is particularly simple and effective, corresponds to the desire often expressed nowadays by most users to have unified communication tools enabling them to organize a conference in a single operation.

The invitation message is sent from a device associated with the conference organizer. By way of example, it may be prepared using an account associated with the organizer and accessible via the organizer's device, e.g. a messaging account, a computer account, or indeed a user account. In the meaning of the invention, sending a message to a device of a third party (conference organizer or participant) includes sending a message to such an account that is accessible by the user's device. Depending on circumstances, the message may be prepared, e.g. by using a dedicated application portal or a conventional electronic messaging application having an application add-on or plug-in.

In accordance with some embodiments of the invention, on being transmitted to the devices of the participants, the invitation message passes via the hardware resource reservation server. On the basis of this invitation message, the resource reservation server obtains the list of the participants invited to the conference and identifies appropriate conference hardware resources for each of the participants. The term “appropriate” hardware resources is used herein to mean hardware resources that are available at the time of the conference and that comply with identified needs of the participants.

In order to find a hardware resource that is appropriate to the conference and to the participants, the reservation server may act during the search process in particular to take account of various types of information such as the geographical location of a participant at the time of the conference. Thus, advantageously, for a participant who is going to be out of office at the time the conference is going to be held, the reservation server can offer a hardware resource that is situated at or near the place where the participant will be at the time of the conference. In a variant, other types of information may be taken into account for determining an appropriate conference hardware resource, e.g. the presence of particular types of equipment, etc.

On the basis of this information, and as a function of the participants, the reservation method identifies conference hardware resources that are appropriate. During this search process, and assuming that pertinent information is available, the hardware resource server can select conference hardware resources that are appropriate, e.g. in terms of capacity, as a function of the number of participants who are physically present on each site.

In the event of this search process being successful, the identified hardware resources are reserved and a first notification message is sent, e.g. by email, to the device of each of the participants concerned in order to inform them of the hardware resources that have been allocated to them. The appropriate hardware resources are thus identified and reserved, likewise in a manner that is transparent for the participants to the conference.

In a particular implementation of the invention, the first notification message is included in the invitation message received from the device of the organizer prior to being sent to the device of the participant in question.

In some embodiments, the invention thus makes it possible to personalize the invitation sent to the device of each participant.

In a particular implementation of the invention, in the event of the search process failing for at least one participant identified in the invitation message, the reservation method comprises sending a second notification message notifying this failure to the device of said participant and/or to the device of the conference organizer.

In this way, on receiving this second notification message specifying the non-availability of conference hardware resources for one of the participants, the organizer can modify the initial organization request in order to take this failure into account (e.g.: change the day or the time of the conference). It is thus possible for the organizer to act in a manner that is transparent for the participant in question to modify the request for organizing a conference in order to ensure that a hardware resource can be allocated to that participant.

In similar manner, when the participant is informed of the failure to make a reservation, the participant may nevertheless decide to participate, in spite of lack of hardware resources, e.g. by using a personal terminal.

In another particular implementation of the invention, the reservation method also comprises sending a third notification message to the device of the conference organizer and specifying the hardware resource reserved for said at least one participant identified in the invitation message.

Advantageously, the organizer is thus informed about progress in the process of reserving hardware resources. The organizer thus knows that a hardware resource has been reserved for the participant in question and that there is therefore no need to modify the organization request for that participant.

Furthermore, when a hardware resource has been allocated to each of the participants, the organizer thus has confirmation that the conference can indeed take place.

In a particular implementation of the invention, the reservation method also comprises:

a modification process of modifying a hardware resource that has been reserved for at least one participant according to at least one information extracted from a message received from a device of at least one participant identified in the invitation message and/or from the device of the conference organizer; and

a send process of sending a fourth notification message notifying this modification to the device of said at least one participant for which the reservation of said at least one hardware resource has been modified.

Where necessary on the basis of responses from the participants, the hardware resource reservation server can thus undertake corrective actions seeking to improve the allocation and the reservation of conference hardware resources. By way of example, the reservation server may adapt the choice of hardware resources as a function of the number of participants who have responded favorably to the invitation, or indeed it may propose a new hardware resource to a participant who has responded with a desire to participate but who has provided additional information as to where that participant will be at the time of the conference.

In a particular implementation of the invention, when a new hardware resource is reserved during the modification process, the fourth notification message notifying the modification specifies the newly reserved hardware resource.

In a variant, the notification message specifying the newly reserved hardware resource may also be included in the invitation message prior to the invitation message being sent to the device of the participant in question.

In another implementation of the invention, the search process of the reservation method comprises, for at least one participant identified in the invitation message:

sending to a remote server selected for that participant a reservation message to reserve a conference hardware resource appropriate for the conference and for said participant; and

receiving a response message from the remote server in response to the request, this response message specifying the conference hardware resource, if any, reserved for the participant.

In other words, it can happen that the hardware resource reservation server does not have direct access to the list of hardware resources that might be made available to a participant. This may apply for example when the participant is not a user known to the resource reservation server. Such a situation may occur in particular when the organizer associated with the reservation server and the participant are located at different geographical sites, in particular sites belonging to different businesses, or indeed when the user and the participant are users of different conference systems operators.

Under such circumstances, and advantageously, the hardware resource reservation server can act on the basis of information about the participant included in the invitation message, such as the identifier of the participant, to identify a remote server associated with the participant and accessible via a telecommunications network. On the basis of this identifier, the reservation server can determine the address of the remote server with which the participant is associated, e.g. by making use of a correspondence table matching the identifier of the participant and the Internet address of the remote server, for example. The reservation server can then interrogate the remote server associated with the participant. If the remote server has knowledge of hardware resources that could be allocated to the participant, it sends a response message to the resource reservation server specifying the hardware resource that has been reserved for the participant, and the resource reservation server then notifies that resource to the device of the participant.

Alternatively, if it has not been possible to identify a remote server, the resource reservation server may propose that the participant makes use of a personal terminal or indeed makes use of a hardware resource reserved for some other participant. Choosing to use such an alternative solution may be predetermined, e.g. as a function of a conference service management policy desired by the organizer or possibly by the operator of the service.

In another particular implementation of the invention, on receiving a message in response to the invitation message coming from a device of at least one participant, the reservation server transfers this response message to the device of the conference organizer. The organizer is thus kept informed of progress in the organization of the conference.

In a particular implementation, the various processes of the reservation method, of the reservation request method, and of the method of receiving an invitation to a conference are determined by computer program instructions. Consequently, in some embodiments, the invention also provides computer programs on data media, the programs being suitable for being performed in a terminal, in a resource reservation server, in a conference server, or more generally in a computer, the program including instructions adapted to performing processes of a reservation method, of a reservation request method, or of a method of responding to an invitation to a conference, as specified above.

The program may make use of any programming language, and it may be in the form of source code, object code, or of code intermediate between source code and object code, such as in a partially compiled form, or in any other desirable form.

In some embodiments, the invention also provides a computer-readable data medium including instructions of a computer program as mentioned above.

The data medium may be any entity or device capable of storing the program. For example the medium may comprise storage means such as a read only memory (ROM), e.g. a compact disk (CD) ROM, or a microelectronic circuit ROM, or indeed magnetic recording means, e.g. a floppy disk or a hard disk.

Furthermore, the data medium may be a transmissible medium such as an electrical or optical signal suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

In another aspect, the invention also provides a conference system comprising:

a first device of a user of a conference and suitable for sending an invitation message to a conference identifying at least one participant to said conference;

at least one second device of said at least one participant; and

a conference hardware resource reservation server of the invention suitable, on receiving the invitation message, for allocating at least one conference hardware resource to said at least one participant.

In a particular embodiment, the conference system further comprises a remote server associated with a participant identified in the invitation message, and wherein:

the search module of the hardware resource reservation server is suitable for sending a reservation request to said remote server to reserve a conference hardware resource appropriate for the conference and for the participant; and

the remote server is suitable for sending a response message to the hardware resource reservation server in response to said request and specifying a conference hardware resource reserved for the participant.

The conference system benefits from the same above-mentioned advantages as the reservation method and server.

In other embodiments, it is also possible to envisage that the reservation method, the resource reservation server, and the system of the invention present some or all of the above-mentioned characteristics in combination.

### BRIEF DESCRIPTION OF THE DRAWINGS

Particular advantages and characteristics of some embodiments of the present invention appear from the following detailed description of the figures, in which:

FIG. 1 shows a video conference system in accordance with the invention in a particular implementation;

FIG. 2 shows an example of hardware architecture for a resource reservation server of the invention; and

FIG. 3 is a flow chart showing the main processes of a method of reserving video conference hardware resources in accordance with a variant implementation of the invention.

### DETAILED DESCRIPTION OF THE INVENTION

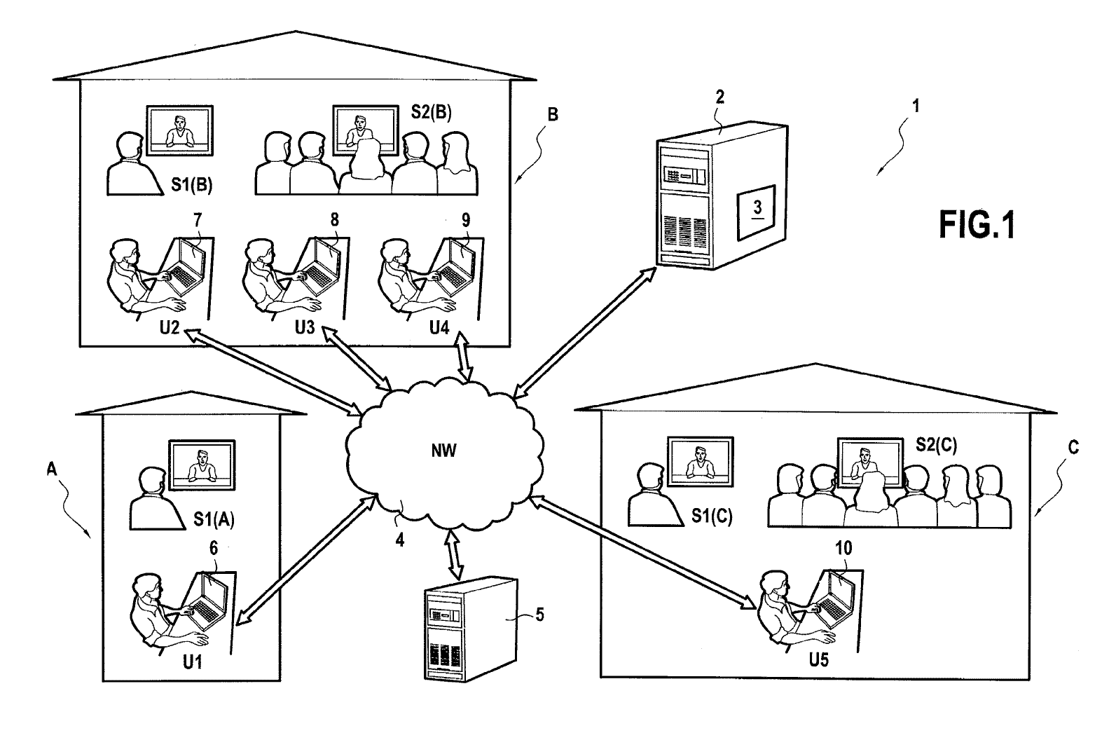

FIG. 1 shows a video conference system 1 in accordance with a particular embodiment of the invention in its environment.

In the example shown in FIG. 1, the video conference system 1 enables the user U1 located at a geographical site A to use a video conference server 2 for organizing a video conference with users U2, U3, U4, and U5. In this example, the users U2, U3, and U4 are hosted on a second geographical site B while the user U5 is located on a third geographical site C.

In accordance with some embodiments of the invention, the system 1 manages the allocation of video conference hardware resources for all of the participants in the video conference organized by the user U1 (in other words for the users U1 to U5).

In the presently-described example, the organizer U1 of the video conference is also a participant in the video conference.

In a variant, the organizer U1 need not be a participant in the video conference. Under such circumstances, no hardware resources are reserved for the organizer U1.

In the presently-described embodiment, the hardware resources allocated by the system 1 are video conference rooms having video conference equipment. Naturally, other types of video conference hardware resources could be envisaged (e.g. a terminal having software enabling it to access a video conference service, a screen, a camera, and/or loudspeakers, etc.).

Thus, in the example shown in FIG. 1, it is assumed that each of the geographical sites A, B, and C has one or more video conference rooms that are connected to one another via a telecommunications network 4.

For example, by way of illustration:

the site A has a video conference room S1(A);

the site B has two video conference rooms S1(B) and S2(B); and

the site C likewise has two video conference rooms S1(C) and S2(C).

Furthermore, the video conference rooms S1(A), S1(B), and S1(C) in this example have the capacity to receive one person, whereas the video conference rooms S2(B) and S2(C) have respective capacities for receiving five people and six people.

Naturally, no limitation is attached to the number of hardware resources available at each geographical site, nor on the nature of the telecommunications network 4. The telecommunications network 4 may thus be a mobile network (e.g. the universal mobile telecommunications system (UMTS)), or a fixed network (e.g. Ethernet), with wired or wireless connections (e.g. a wireless local area network (WLAN)), and it may be private or public, etc.

In addition, the video conference rooms in question may equally well be conventional dedicated rooms, immersive rooms, or indeed ordinary meeting rooms fitted with a personal computer suitable for use with video conference applications, etc. No limitation is attached to the nature of these rooms providing they are fitted with video conference hardware means and that they are connected to one another, e.g. via one or more telecommunications networks 4.

In accordance with some embodiments of the invention, the video conference system 1 comprises:

a first device 6 associated with the organizer U1 of the video conference;

a plurality of devices 7, 8, 9, and 10 associated respectively with each of the users U2, U3, U4, and U5 invited to participate in the video conference organized by the user U1; and

a hardware resource reservation server 3 in accordance with the some aspects of the invention that specifically carries out the allocation of video conference hardware resources to the users U1-U5, as appropriate firstly for the video conference being organized by the user U1, and secondly for each of the users U1-U5.

It should be observed that the hardware resource reservation server 3 does not necessarily have direct access to the hardware resources, in other words, it need not necessarily reserve these resources itself on behalf of the users U1 to U5, but may be required to communicate with a third server (e.g. a remote server accessible via the telecommunications network 4) in order to make such reservations. Thus, in the example shown in FIG. 1, it is assumed that the reservation server 3 has access to the hardware resources S1(A), S1(B), and S2(B), but that the hardware resources S1(C) and S2(C) are managed by a remote server 5.

In the presently-described embodiment, the devices of the users U1 to U5 are terminals, such as desktop or laptop computers, for example, having electronic messaging software including an added application enabling their respective users to access the reservation server 3 via a user account, e.g. such as an electronic messaging account to which the reservation server is attached. Such electronic messaging software is itself known and is not described in detail herein.

Alternatively, only the terminal 6 of the organizer U1 is fitted with electronic messaging software having application software, while the terminals 7, 8, 9, and 10 of the other participants (U2-U5) have conventional messaging software, only.

In a variant, the devices of the users U1 to U5 are fitted with conventional software giving access to a dedicated application portal or to an on-line messaging service, e.g. such as a web browser.

In the presently-described particular embodiment, the resource reservation server 3 is incorporated in the video conference server 2. Thus, the video conference server 2 differs from a conventional video conference server in that it includes a resource reservation server in accordance with the invention.

In a variant, the hardware resource reservation server 3 may be located in a software or hardware device that is independent of the video conference server 2.

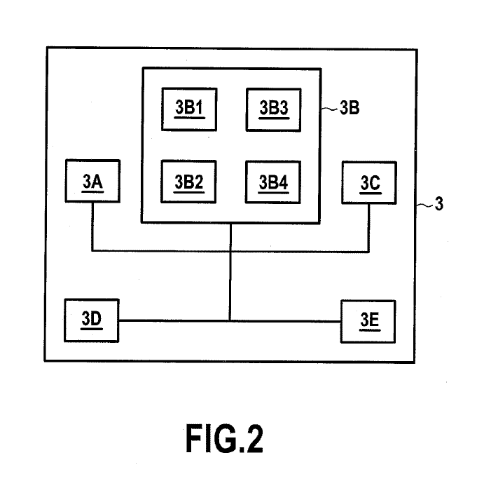

In this example, the reservation server has the hardware architecture of a computer, as shown diagrammatically in FIG. 2.

In particular, it comprises a processor 3A, a ROM 3B, a random access memory (RAM) 3C, a non-volatile memory 3D, and communications means 3E for communicating over the telecommunications network 4. The processor 3A, the memories 3B-3D, and the communications means 3E may possibly be shared with corresponding means of the video conference server 2.

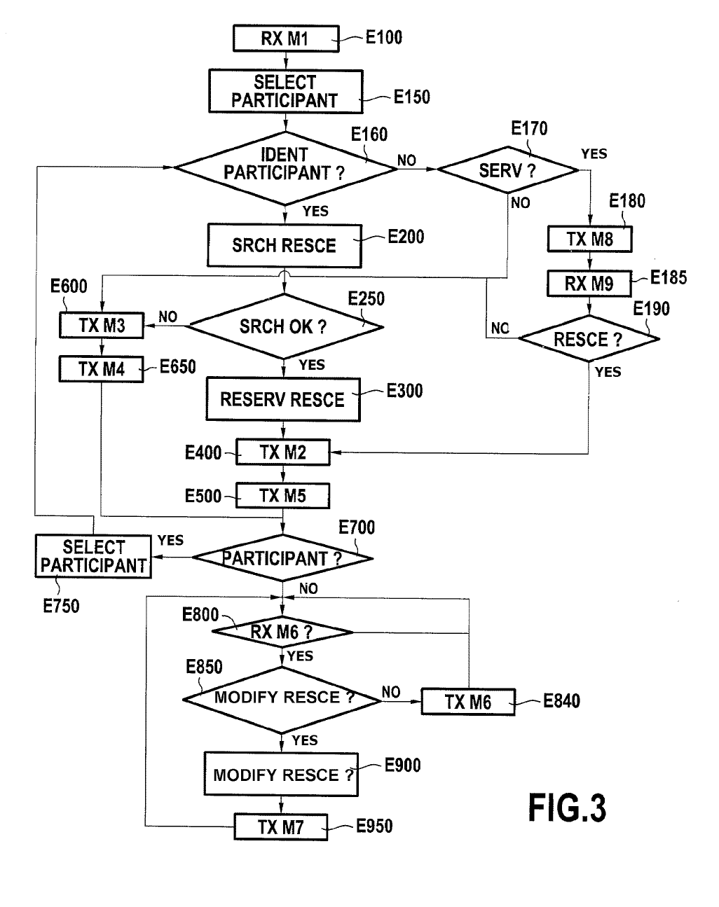

The ROM 3B of the hardware resource reservation server constitutes a data medium readable by the processor 3A and it stores a computer program in accordance with some aspects of the invention, including instructions for executing processes of a reservation method in accordance with some aspects of the invention, the processes of the reservation method being described below with reference to FIG. 3 in a particular implementation.

The computer program defines in equivalent manner functional modules (software) of the hardware resource reservation server 3, such as in particular a receive module 3B1 for receiving an invitation message to a video conference coming from a device of a user and identifying at least one participant to the video conference, a search module 3B2 for searching for hardware resources appropriate for the video conference and for the participant, a reservation module 3B3 for reserving these hardware resources, and a send module 3B4 for sending notification messages to the devices of the participants to the video conference. The receive functional module 3B1 and the send functional module 3B4 make use in particular of the communications means 3E of the reservation server 3. Their functions are described in greater detail below with reference to the processes of the reservation method shown in FIG. 3.

FIG. 3 shows the main processes of a hardware resource reservation method of the invention in a particular implementation in which it is performed by the hardware resource reservation server 3.

It is assumed that the user U1 makes use of the terminal 6 to prepare an invitation message M1 to attend a video conference, which message is sent to the users U2, U3, U4, and U5. In this example, the invitation message M1 is sent from an electronic messaging account associated with the organizer U1 and accessible via the terminal.

Thus, in this example, the invitation message M1 is in the conventional form of an email message. It includes the identifiers of each of the participants invited to the video conference, specifically in this example the users U2, U3, U4, and U5. By way of example, these identifiers are the email addresses to which the invitation message M1 can be sent.

In a process E100, the invitation message M1 is received by the hardware resource reservation server 3 using its receive module 3B1. For this purpose, although the invitation message M1 is addressed to the terminals 7, 8, 9, and 10 of the users U2 to U5, it may be sent directly by the terminal 6 to the reservation server 3 (e.g. via an appropriate configuration of the messaging account associated with the user U1 via which the invitation message is sent), or in a variant, the reservation server 3 may be arranged in series in the stream of messages sent by the devices of the users U1 to U5 concerning organizing and participating in video conferences.

On receiving the message Ml, the reservation server 3 acts during a process E150 to identify a first participant to the video conference. This participant may be the organizer U1 of the video conference, i.e. the person using the device 6 to send out the message Ml, if that person is to participate in the video conference; or this participant could be one of the participants to the video conference identified in the invitation message Ml, such as for example the participant U2. It is assumed in this example that the selected participant is the participant U2.

Thereafter, the reservation server 3 acts during a process E160 to determine whether it has direct access to the list of hardware resources that could be made available for the selected participant U2.

In the presently-described implementation, a video conference room is allocated to a participant by the reservation server 3, while taking account of the geographical location of the participant.

If the reservation server 3 does not have access to this list (response “no” to process E160), it seeks to make use of information about the participant U2 contained in the invitation message M1 for the purpose of identifying a remote server 5 (i.e. a server that is accessible via a telecommunications network) that is associated with the participant U2 and that has access to video conference hardware resources that can be made available to the participant U2.

The remote server 5 is identified in this example by making use of the electronic messaging address of the participant U2 as contained in the message Ml. On the basis of this electronic address, the reservation server determines the address of the remote server 5 with which the participant U2 is associated, e.g. by making use of a correspondence table matching the domain name of the messaging address of the participant U2 with the Internet address of the remote server 5.

Thereafter, during a process E180, the reservation server 3 sends to the remote server 5 a reservation request M8 requesting reservation of a video conference hardware resource appropriate for the video conference proposed by the user U1 and for the participant U2. The term “appropriate” is used herein to mean a hardware resource, and more particularly a video conference room, that is available at the time specified for the video conference and that is geographically located on the same site as the participant U2.

On receiving a response message M9 (process E185) from the remote server 5 identifying such a video conference hardware resource that has been reserved for the participant U2, the reservation server 3 acts during a process E400 to use its send module 3B4 to send a first notification message M2 notifying the participant U2 of the video conference room that has been reserved for that participant.

If the remote server 5 has not been able to reserve any room (response “no” to process E190), the reservation server 3 sends a notification message M3 to the device 7 of the participant U2 and a notification message M4 to the device 6 of the organizer U1 in order to inform them of this failure, in processes E600 and E650. The notification messages M3 and M4 are “second” notification messages in the meaning of the invention.

In a variant, the reservation server 3 sends a notification message M3 only to the device 7 of the participant U2.

In another variant, the reservation server 3 sends a notification message M4 only to the device 6 of the organizer U1.

If the participant U2 forms one of the users for whom the reservation server 3 has access to a list of video conference rooms that could be made available to those users (response “yes” to process E160), the server then uses its search module 3B2 to search for a video conference room that is both appropriate for the video conference organized by the user U1 (in particular in terms of availability at the corresponding times) and also appropriate for the user U2, and in particular in this example at the same geographical location as the user U2 at the time of the video conference.

For this purpose and by way of example, the hardware resource reservation server 3 makes use of the active directory, of the business, of the address book of the participant U2, of the electronic diary of the participant U2, or of any other means to identify the geographical location of the participant U2 at the time of the video conference.

In the same way, the reservation server 3 obtains the same information for the other users U1, U3, U4, and U5. If the geographical location of a participant at the time of the video conference cannot be determined, e.g. because the reservation server 3 does not have access to the electronic diary of that participant, then the site at which that participant is usually present is selected (i.e. a site defined by default).

Depending on the location of the user U2 at the time of the video conference, and in particular depending on the hardware resources available and the number of participants who have been identified as being present at that location, the hardware resource reservation server 3 acts during a process E200 to determine a video conference room appropriate for the user U2.

In this example, it is assumed that the video conference room S2(B) is selected, since the reservation server 3 has identified the presence of the participant U2 at the site B at the time of the video conference, together with the presence on the same site of two other participants U3 and U4 also invited to the video conference.

Once the hardware resource S2(B) has been determined (response “yes” to process E250), the video conference room S2(B) is reserved by the reservation server 3 during a process E300 by making use of its reservation module 3B3. Thereafter, during a process E400, the reservation server 3 notifies the participant U2 of the hardware resource that has been reserved for that participant by using a first notification message M2 that is sent to the device 7 of the participant U2 as determined by that participant's identifier, e.g. an email address, as present in the invitation message M1. When the participant is also the organizer of the video conference, it is assumed that the corresponding identifier is also present in the invitation message M1, either as a participant or else as the sender of the invitation message.

The first notification message M2 may be sent to the device of the participant U2 in a manner that is independent of the invitation message M1. It may also be incorporated in the invitation message M1 before that message is sent to the device of the participant U2. Under such circumstances, the invitation message M1 including the first notification message M2 becomes a personalized invitation message to the video conference for the participant U2.

In the presently-described implementation, the hardware resource reservation server 3 also sends a notification message M5 to the device of the organizer U1 in a process E500; this message is a “third” message in the meaning of the invention, and it specifies the hardware resources that have been reserved for the participant U2.

In the presently-described implementation, in the event of the search for a conference room appropriate for the user U2 and appropriate for the video conference failing (response “no” to process E250), the reservation server 3 sends a notification message M3 to the device of the user U2 during a process E600. Thereafter, during a process E650, the reservation server 3 also sends a notification message M4 to the device of the organizer U1. The messages M3 and M4, which are “second” notification messages in the meaning of the invention, enable the user U1 and the participant U2 to be informed about the failure of the search for a hardware resource appropriate for the video conference and for the user U2.

In a variant, the reservation server 3 sends a notification message M3 only to the device 7 of the participant U2.

In another variant, the reservation server 3 sends a notification message M4 only to the device 6 of the organizer U1.

In another implementation of the invention, the second notification message M3 also includes an invitation to connect remotely to the video conference if the service makes that possible, or indeed a list of hardware resources allocated to other participants, which the participant U2 may also choose to use.

If there remain participants to the video conference (the organizer or some other participant) for which a search for a hardware resource has not yet been made (response “yes” to process E700), then the reservation server 3 identifies a new participant (possibly the organizer) during a process E750 and repeats processes E160 to E700.

In the presently-described implementation, the processes E160 to E600 are performed sequentially for each of the participants invited to the video conference as identified in the invitation message M1, and also where appropriate for the organizer U1. In a variant, the processes E160 to E600 may be performed simultaneously for each of the participants (U1-U5) in parallel.

In the presently-described implementation, after the reservation server 3 has searched for a video conference hardware resource for each participant (U1-U5) invited to the video conference as identified in the invitation message M1, and has allocated that resource if its search is successful, it performs a new stage during which it might vary the hardware resource reservations that have already been made on the basis of information returned by the participants about the invitation issued by the organizer U1 or about the reservations made by the reservation server 3.

In particular, by way of example and in non-limiting manner, a participant may use a message M6 to inform the reservation server 3 that that participant is not going to participate in the video conference, or will be participating using a personal terminal, or indeed desires to participate to the video conference but from a geographical site other than the site where the video conference room is located that has been proposed by the reservation server 3.

The organizer might also decide to modify the initial invitation, for example by changing the time of the video conference or the participants invited to the video conference (e.g. adding and/or removing participants).

In the presently-described implementation, the reservation server 3, on receiving a message M6 (process E800) from a device of a participant identified in the invitation message M1 and/or coming from a device of the organizer U1 of the video conference, may adapt the previously made reservation of hardware resources.

During a process E850, the hardware resource reservation server 3 determines whether the reservation of a hardware resource needs to be modified, at least on the basis of information contained in the invitation message M1 and in the message M6.

When it is necessary to modify the reservation of a hardware resource (response “yes” to process E850), the reservation server 3 acts during a process E900 to update the reservation of hardware resources accordingly, and then it notifies the device(s) of the participant(s) concerned of the modification that has been made by sending them (process E950) a fourth notification message M7.

If there is no need to update the reservation of hardware resources (response “no” to process E850), the hardware resource server acts in a process E840 to transfer the response message M6 from the participant to the organizer of the video conference so as to inform the organizer about how the reservation process is proceeding.

In the presently-described implementation, the invention is described in the context of organizing a video conference where it is necessary to reserve hardware resources that are appropriate for that video conference. It should be observed that the some aspects of the invention also apply to organizing an audio conference in a manner that is identical or similar.

1. A reservation method performed by a conference hardware resource reservation server, the method comprising:
receiving an invitation message to a conference from a device associated with an organizer of the conference, said invitation message identifying at least one participant different from the organizer of said conference;
a search process performed on behalf of said at least one participant identified in the invitation message, of searching for a conference hardware resource appropriate for said conference and for said participant;
a reservation process performed on behalf of said at least one participant, of reserving the hardware resource, if any, identified during the search process; and
sending a first notification message to a device of said at least one participant, said first notification message specifying said hardware resource reserved for that participant.

2. A method according to claim 1, wherein said search, reservation, and sending processes are also performed for said organizer of the conference.

3. A method according to claim 1, wherein the first notification message is included in the invitation message received from the device of the organizer prior to being sent to the device of said at least one participant.

4. A method according to claim 1, including, in the event of said search process failing for at least one participant identified in the invitation message, sending a second notification message notifying this failure to the device of said participant and/or to the device of the organizer of the conference.

5. A method according to claim 1, further comprising sending a third notification message to the device of the organizer of the conference, said third notification message specifying the hardware resource reserved for said at least one participant.

6. A method according to claim 1, comprising:
modifying a hardware resource reservation for at least one participant according to at least one information extracted from a message received from a device of at least one participant identified in the invitation message and/or from the device of the organizer of the conference; and
sending a fourth notification message notifying this modification to the device of said at least one participant for which the reservation of said at least one hardware resource has been modified.

7. A method according to claim 6, wherein, when a new hardware resource is reserved during the modification process, the fourth notification message notifying the modification specifies the newly reserved hardware resource.

8. A method according to claim 1, wherein the search process comprises, for at least one participant identified in the invitation message:
sending to a remote server selected for that participant a reservation message to reserve a conference hardware resource appropriate for said conference and for said participant; and
receiving a response message from the remote server in response to said request, said response message specifying the conference hardware resource, if any, reserved for the participant.

9. A method according to claim 1, wherein the search process takes account of a geographical location of said at least one participant during said conference.

10. A method according to claim 1, further comprising:
receiving a response message in response to the invitation message from a device of at least one participant; and
transferring this response message to the device of the organizer of the conference.

11. A conference hardware resource reservation server comprising:
a reception module which receives an invitation message to a conference from a device of an organizer of the conference, said invitation message identifying at least one participant different from the organizer of said conference;
a search module which acts on behalf of said at least one participant identified in the invitation message, to search for a conference hardware resource appropriate for said conference and for said participant;
a reservation module which reserves the hardware resource, if any, identified for said at least one participant; and
a send module which sends a notification message to a device of said at least one participant, said notification message specifying said hardware resource reserved for that participant.

12. A conference system comprising:
a first device of an organizer of a conference and suitable for sending an invitation message to said conference identifying at least one participant to said conference;
at least one second device of said at least one participant; and
a conference hardware resource reservation server according to claim 13 suitable, on receiving the invitation message, for allocating at least one conference hardware resource to said at least one participant.

13. A conference system according to claim 12, further comprising a remote server associated with a participant identified in the invitation message, and wherein:
the search module of the hardware resource reservation server is suitable for sending a reservation request to said remote server to reserve a conference hardware resource appropriate for said conference and for the participant; and
the remote server is suitable for sending a response message to the hardware resource reservation server in response to said request to specify a conference hardware resource reserved for the participant.

14. A method performed by a device of an organizer of a conference for requesting the reservation of conference hardware resources, the method comprising sending an invitation message to said conference to a reservation server, said invitation message identifying at least one participant distinct from the organizer of said conference.

15. A method according to claim 14, comprising receiving a notification message from said reservation server, said message specifying a conference hardware resource reserved by said server for the organizer and/or for said at least one participant identified in the invitation message, or specifying a failure of searching for a conference hardware resource for the organizer and/or for said at least one participant identified in the invitation message, said hardware resource being appropriate for said conference and for said at least one participant and/or for said organizer.

16. A method of receiving an invitation to a conference by a device of at least one participant, the method comprising receiving a notification message from a reservation server, said notification message specifying a hardware resource reserved by said server for said at least one participant, said hardware resource being appropriate for said conference and for said at least one participant.

17. A computer program including instructions for executing the reservation method according to claim 1, when said program is executed by computer.

18. A computer program including instructions for executing the reservation request method according to claim 14, when said program is executed by computer.

19. A computer program including instructions for executing the method of receiving an invitation to a conference according to claim 16, when said program is executed by computer.

20. A non-transitory computer-readable data medium storing a computer program comprising instructions for executing the reservation method according to claim 1.

21. A non-transitory computer-readable data medium storing a computer program comprising instructions for executing the reservation request method according to claim 14.

22. A non-transitory computer-readable data medium storing a computer program comprising instructions for executing the method of receiving an invitation to a conference according to claim 16.
